(19) United States
(12) Patent Application Publication
(10) Pub. No.: US 2009/0011719 A1
(43) Pub. Date: Jan. 8, 2009

(54) Radio Communication System and Method

(76) Inventors: Dmitry Khabashesku, Houston, TX (US); David Alexander Carr, Houston, TX (US)

Correspondence Address: 24IP LAW GROUP USA, PLLC, 12 E. LAKE DRIVE, ANNAPOLIS, MD, 21403, US

(21) Appl. No.: 11/772,368

(22) Filed: Jul. 2, 2007

(51) Int. Cl. H04B 1/40

(52) U.S. Cl. 455/77

(57) ABSTRACT

A two-way radio system and method in which a virtual channel code is selected for a particular group of radios. On transmit, the transmitting radio searches for a free radio channel and begins to transmit the voice audio as well as the chosen virtual channel code when a free channel is found. Meanwhile, receiving radios continuously scan through all 14 radio channels. When a carrier is detected in a given radio channel, the receiver checks to see if the virtual channel code on that channel matches the selected tone. If the tone matches, the squelch is opened otherwise the receiver continues to scan.

### CROSS-REFERENCE TO RELATED APPLICATIONS

None.

### STATEMENT REGARDING FEDERALLY SPONSORED RESEARCH OR DEVELOPMENT

### BACKGROUND OF THE INVENTION

1. Field of the Invention

The present invention relates systems and methods for two-way radio communications.

2. Brief Description of the Related Art

The Family Radio Service (FRS) is a popular two-way radio communication system operating in the UHF band. Radios for this system are inexpensive, require no license and therefore enjoy widespread use in a variety of recreational and commercial activities. Unfortunately, FRS radios are a victim of their own success. Today in busy areas such as campgrounds and ski resorts the FRS channels are choked with activity and inter-user interference is common. In comparison to other widespread wireless networks such as cellular-based Personal Communication System (PCS) networks, the FRS radio system has poor channel utilization efficiency, a poor user interface and as a result poor reliability. We have identified that the source of the problems with FRS system can be traced to its minimal and simplistic communications protocol. We have devised some modifications to the FRS protocol, which greatly improve the potential channel utilization efficiency of the FRS band, simplify the user interface, and make transmissions more reliable. Our solution is simple, easy to implement using existing technology and very low cost. In addition, our solution offers compatibility with the existing FRS communications protocol, offering a low-risk opportunity to integrate our solution into existing FRS networks.

Each network has its own guidelines, implementation details, and limitations that influence important factors, such as the maximum user capacity, transmission reliability, scalability, security, and ease of use. For example, cellular personal communications system (PCS) radios and mobile two-way radios operating in the Family Radio Service (FRS) band are quite different in terms of the above factors. In cellular PCS networks, establishing communications with a distant user is as easy as dialing a phone number, as on a telephone.

The FRS/GMRS allows users of FCC type certified radios to transmit narrow band FM audio signals on one of a limited number of center frequencies with a low output power. All audio transmissions must be intended to be two-way communications. Digital transmissions are allowed provided that they are initiated by user action and are limited to a maximum duty cycle of 1 second every 30 seconds. Because FRS voice signals are usually high-pass filtered with a cutoff of 300 Hz, the FCC refers to all signals below this frequency as “subaudible”. FRS radios are allowed to continuously transmit subaudible tones while the PTT button is depressed.

Several technologies exist for solving the multiple simultaneous access problem in radio networks, namely TDMA, CDMA and FDMA. TDMA and CDMA system utilize relatively broad sections of bandwidth to carry multiple conversations simultaneously. In TDMA these conversations are sliced up in short segments and time multiplexed over the channel. CDMA uses orthogonal coding schemes to make the different signals orthogonal to each other so that they may be transmitted simultaneously. Unfortunately, the FCC requirements for the FRS band require the use of narrow band FM modulation on specific channel frequencies. Furthermore, data transmission is not permitted except in very limited cases. These requirements rule out advanced multiplexing schemes and require that we use the standard multi-channel (FDMA) multiplexing approach.

Another existing protocol, the Continuous Tone Coded Squelch System (CTCSS), make use of subaudible tones to provide a form of multi-user channel access. In the CTCSS system, each user group selects one of 38 tone frequencies between 67.0 and 250.3 Hz. When a user transmits, his radio transmits a tone of the chosen frequency in the subaudible portion of the channel. Receiving radios analyze the subaudible tone on incoming transmissions. If the incoming subaudible tone matches the frequency of the current selected tone then the squelch is opened, otherwise the squelch remains closed. This protocol enables users to ignore transmissions from other users on the same channel. It does not however, allow multiple users to use the same channel at the same time. A common problem with the CTCSS protocol is that it tends to result in large numbers of transmit collisions. The problem occurs when a user is using the channel with one CTCSS tone and another user with a different CTCSS tone decides to use the channel as well. The second user cannot hear the first user because of the difference in CTCSS tones and thus assumes the channel is clear and begins to transmit. This obviously results in a collision with at most one of the users getting through. Most radios do have a receive active indicator that could be used to avoid this situation. However most users do not understand the meaning of this indicator or simply ignore it.

### SUMMARY OF THE INVENTION

In a preferred embodiment, the present invention is a two-way radio system and method in which a virtual channel code is selected for a particular group of radios. On transmit, the transmitting radio searches for a free radio channel and begins to transmit the voice audio as well as the chosen virtual channel code when a free channel is found. Meanwhile, receiving radios continuously scan through all 14 radio channels. When a carrier is detected in a given radio channel, the receiver checks to see if the virtual channel code on that channel matches the selected tone. If the tone matches, the squelch is opened otherwise the receiver continues to scan.

The present invention is a system and method for providing two-way radio communication. In one preferred embodiment, the present invention addresses the shortcomings of the CTCSS protocol built into the FRS communication system. As mentioned earlier, these shortcomings include poor user interface, no solution to the problem of transmission collision, and poor overall utilization of the allocated spectrum for FRS. Specifically, the present invention will work within the current legal specifications for the FRS band set forth by the FCC. This includes obeying specifications for maximum radiated power, modulation type, transmission bandwidth and nature of the data being transmitted. This makes the present invention easy to deploy gradually, minimizes costs associated with the transition and maintains support for legacy users. While the present invention may be used with and within current legal requirements, it may be used outside of the current legal requirements and with systems that operate outside those current legal requirements.

The present invention further improves the spectrum utilization of the FRS band. Specifically, with the present invention, the bandwidth of a transmission need not be changed by digitizing and compressing the signal, which permits compliance with FCC specifications for analog FM transmission of audio data in the FRS band. The present invention achieves improvement of the spectrum utilization of the FRS band without employing spread spectrum or channel multiplexing techniques (CDMA, TDMA, FDMA) to reallocate the spectrum, although such methods and systems could be used with the present invention.

Further, the present invention reduces the probability of transmission collisions. In conventional systems, a collision between two FRS transmitters typically corrupts the signal and renders it unintelligible to any receivers on the same channel. Since there is no way to mitigate the effects of a collision, the present invention provides for avoidance of such collisions as often as possible.

The present invention further improves the user interface of an FRS radio system. In the current FRS system, it is left up to the user to decide when to transmit their signal, what channel to use, and how to filter out unwanted transmissions. This is a lot to expect from an amateur/casual user of a communication system, and is a barrier to widespread adoption of the FRS radio system. The present invention overcomes this problem.

Another advantage of the present invention is that systems utilizing the present invention should not cost significantly more than a legacy FRS radio system. This includes both operating costs and initial hardware investment costs. Since an FRS radio network is ad-hoc and requires no central base station to operate, the operation cost falls entirely on the user. The present invention provides for continued low-cost systems. Further, the system and method in accordance with the present invention may be backward compatible with existing radio systems and/or may be achieved by modifications to existing radio systems or designs.

The present invention further provides for low transmit and receive latency. This means that the time between when the user pushes the Talk button and when the transmission begins is low enough to be almost imperceptible. Also, the time between when a transmission appears on the channel and when the receiver recognizes and starts receiving the transmission is low enough to avoid cutting off the start of the transmission.

In a preferred embodiment, the present inventions satisfies the following specifications:
The radio system operates for a minimum of 24 hours. This number is based on the use case for a typical FRS radio. If the radio is used for an average of 12 hours a day (based on a 5% transmit, 5% receive, 90% idle use pattern), this provides for two days of operation between recharges. Given that a AAA battery has a nominal capacity of 1 Ah, the radio's average current draw should be less than 42 mA.
Based on samples of several off-the-shelf FRS radios, the typical current draw for a radio is 30 mA. A preferred embodiment of the present invention satisfies a power budget of 12 mA to use for any additional hardware added to the system.
The radio system must not have degraded transmission range relative to an unmodified FRS radio.
The system interface to the radio consists of a single channel identifier, a talk button, and a user friendly way to change the channel identifier.
The time between pushing the Talk button and the radio beginning transmission must be less than 500 ms. Also, the time between when a transmission appears at the receiver and the receiver unsquelches must be less than 500 ms. These numbers are based on the motor reaction time of a person when they push the talk button, realize that the radio is ready to transmit (say, by observing a “Ready to Transmit” light on the radio illuminating), and begin talking.

In a preferred embodiment, the present invention is a method of two-way radio communication using a radio having a memory, a plurality of channels, a plurality of virtual channel codes and a transmit button, wherein the radio has a current channel stored in the memory. The method comprises the steps of: (1) storing a selected virtual channel code in the memory; (2) determining whether the current channel is clear when the transmit button is pressed; (3) changing the current channel stored in memory to a different channel if the current channel is not clear; (4) repeating steps (2) and (3) until a clear channel is found; and (5) when a clear channel is found, transmitting audio and the selected virtual channel code on the clear channel. The virtual channel code may be a CTCSS tone. The plurality of channels may comprise a lowest channel, highest channel and a plurality of channels in between the lowest channel and the highest channel. The step of changing the current channel stored in memory to a different channel may comprise incrementing the current channel sequentially by one from the lowest channel to the highest channel and returning to the lowest channel after determining that the highest channel is not clear. Alternatively, the step of changing the current channel stored in memory to a different channel may comprise selecting a new channel randomly. In one embodiment, the user may select the virtual channel code.

In another embodiment, the present invention is a method of two-way radio communication using a radio having a memory, a plurality of channels, a plurality of virtual channel codes and a transmit button, wherein the radio has a current channel stored in the memory. The method comprises the steps of: (1) storing a selected virtual channel code in the memory; (2) determining whether the current channel in the radio is clear; (3) if the current channel in the second radio is clear, changing the current channel stored in the memory of the second radio to a different channel; (4) repeating steps (2) and (3) until a channel is found that is not clear; (5) when a channel that is not clear is found, determining whether a received virtual channel code matches the selected virtual channel code, unsquelching a receiver in the radio if the received virtual channel code matches the selected virtual channel code, and squelching the receiver, changing the current channel to a different channel, and returning to step (2) if the received virtual channel code does not match the selected virtual channel code.

In still another embodiment, the present invention is a method of two-way radio communication using a plurality of radios each having a memory, a plurality of channels, a plurality of virtual channel codes and a transmit button, wherein each the radio has a current channel stored in the memory. The method comprises the steps of: (1) storing a selected virtual channel code in the memory of each of a first and second of the plurality of radios; (2) determining whether the current channel of the first radio is clear when the transmit button on the first radio is pressed; (3) changing the current channel stored in the memory of the first radio to a different channel if the current channel is not clear; (4) repeating steps (2) and (3) until a clear channel is found; and (5) when a clear channel is found, transmitting audio and the selected virtual channel code on the clear channel. The method may further comprise the steps of: (6) determining whether the current channel in the second radio is clear; (7) if the current channel in the second radio is clear, changing the current channel stored in the memory of the second radio to a different channel; (8) repeating steps (6) and (7) until a channel is found that is not clear; (9) when a channel that is not clear is found, determining whether a received virtual channel code matches the selected virtual channel code, unsquelching a receiver in the second radio if the received virtual channel code matches the selected virtual channel code, and squelching the receiver, changing the current channel to a different channel, and returning to step (6) if the received virtual channel code does not match the selected virtual channel code.

Still other aspects, features, and advantages of the present invention are readily apparent from the following detailed description, simply by illustrating a preferable embodiments and implementations. The present invention is also capable of other and different embodiments and its several details can be modified in various obvious respects, all without departing from the spirit and scope of the present invention. Accordingly, the drawings and descriptions are to be regarded as illustrative in nature, and not as restrictive. Additional objects and advantages of the invention will be set forth in part in the description which follows and in part will be obvious from the description, or may be learned by practice of the invention.

### BRIEF DESCRIPTION OF THE DRAWINGS

For a more complete understanding of the present invention and the advantages thereof, reference is now made to the following description and the accompanying drawings, in which:

FIG. 1 is a flow diagram for a system in accordance with a preferred embodiment of the present invention.

FIG. 2 is a circuit diagram of a prior art radio.

FIG. 3 is a circuit diagram of a daughter board for modifying the circuit of FIG. 2 in accordance an example of the present invention.

### DETAILED DESCRIPTION OF THE PREFERRED EMBODIMENTS

The present invention solves two problems: the inefficient channel use caused by fixed radio group to channel mappings and also the transmit collision problem associated with the CTCSS protocol. The present invention allows a radio party to choose a sub audible tone frequency (as in CTCSS) but not a channel. The party's CTCSS tone frequency in effect represents their chosen virtual channel. While there are more than twice as many CTCSS tones than channels (38 vs. 14), the preferred embodiment of the present invention could suffer from a milder form of non-uniform channel selection problem. To mitigate this possibility, its is suggested that instead of allowing users to choose a CTCSS tone directly, that users choose a common identifier such as “David's Group”. This identifier would then be mapped to one of the CTCSS tones using a hash function chosen to provide relatively uniform virtual channel allocation.

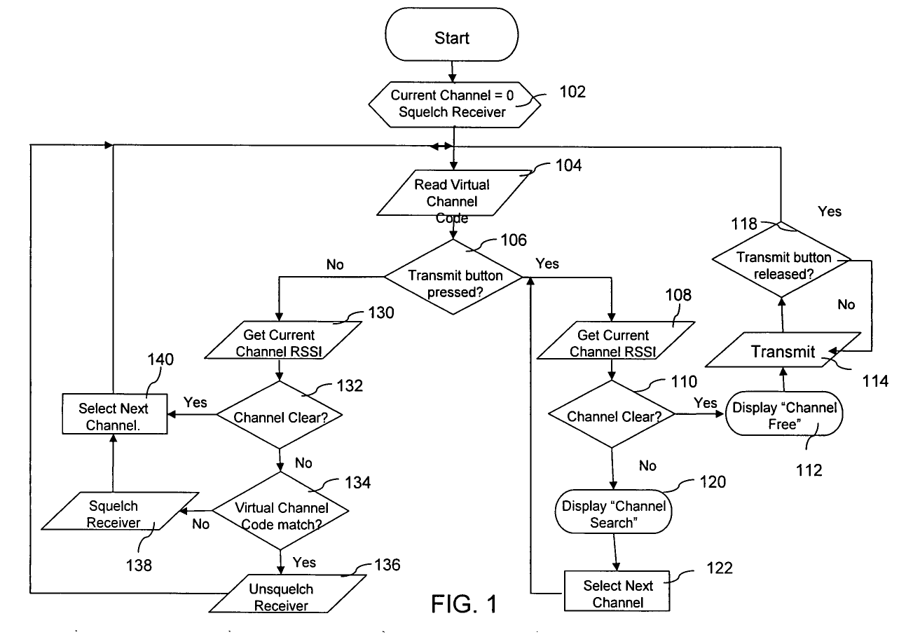

The operation of a preferred embodiment of the present invention is described with reference to FIG. 1. Each radio has a stored current channel and a stored current virtual channel code. The current channel may be any available channel and the current virtual channel code may be any available virtual channel code. For purposes of example, the current channel in FIG. 1 at step 102 is Channel 0. Once each group has chosen a CTCSS tone or virtual channel code (step 104), operation of the protocol proceeds as follows. On transmit (step 104), the transmitting radio searches for a free radio channel by getting the current channel RSSI (step 108) and then determining whether that channel is clear. If the channel is not clear, a message such as “Channel Search” is displayed on the radio (step 120), the next channel is selected (step 122), and the system returns to step 108. This is repeated until a clear channel is found. The “next channel” may be chosen in any manner, such as sequential, random, or even in a sequence pre-programmed by radio manufacturer or the user. Furthermore, information regarding the signal strengths on various channels detected during a prior search or searches for incoming transmissions could be cached or stored and used to determine a channel search sequence that could improve the speed at which a clear channel is found. For example, the channels previously having the lowest signal strength could be search first. If the channel is clear at step 110, a “Channel Free” message is displayed (step 112) and the transmission of the voice audio and the chosen CTCSS tone or virtual channel code begins (step 114). The transmission continues until the transmit button is released (step 116).

Meanwhile, receiving radios, i.e., radios whose transmit buttons are not pressed (step 106) continuously scan through all 14 radio channels. More specifically, they get the current channel RSSI (step 130) and determine whether the channel is clear (step 132). When a carrier is detected in a given radio channel, the receiver checks to see if the CTCSS tone on that channel matches the selected tone (step 134). If the tone matches, the squelch is opened otherwise the receiver continues to scan (step 136). If the at step 134 the virtual channel code is not a match, the receiver remains squelched (step 138), the next channel is selected (step 140) and the system returns to step 104.

These simple changes to the CTCSS protocol produce a dramatic effect. Using the present invention, all 14 channels must be use before a collision occurs (as long as no two users have the same code). Users may press the transmit button at any time and be virtually guaranteed that they will begin transmitting a free channel and without interfering with other users. Furthermore, the number of virtual channels has been more than doubled and the allocation of these channels has been made more uniform. These two effects combine to significantly reduce the chance that two users on the same virtual channel will want to transmit at the same time. It also is significant that the present invention falls entirely within the existing rules of the FRS service as defined by the FCC.

### EXAMPLE

For demonstration purposes, the feasibility of implementing the present invention in an FRS radio, a reference implementation was constructed. One of the goals of the reference implementation was to resemble a conventional FRS radio as much as possible. Ramrod-enabled radios should not require significant changes in performance, cost or power consumption as compared to existing FRS designs. For simplicity, an existing FRS radio, the Cobra PR-950 was modified to implement the present invention.

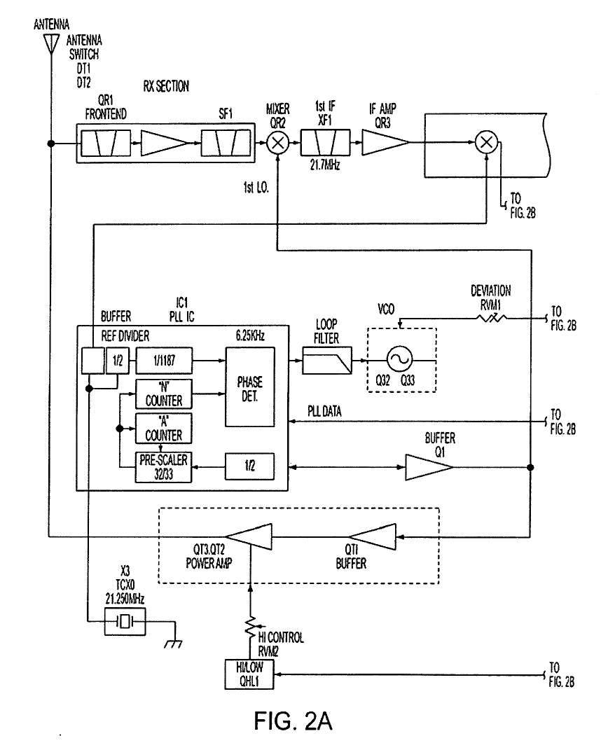

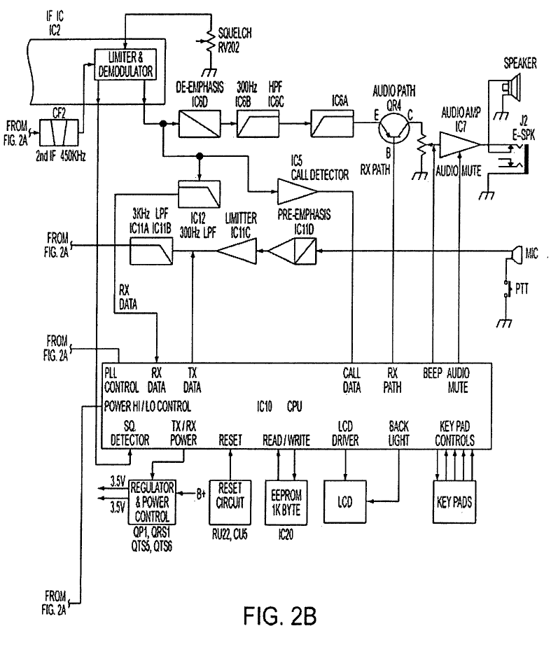

Several signals in the PR-950 block diagram shown in FIG. 2 are important to the modifications required to implement the present invention. In the preferred embodiment of the present invention, the radio scans through all 14 FRS channels as rapidly as possible when searching for transmitted signals. In order to change the receive frequency rapidly and precisely it is necessary to control the PLL directly. This is accomplished by disconnecting the radio CPU from the lines marked PLL_DATA and controlling these lines externally. In order to determine whether or not a carrier is present on a given channel, a received signal strength indication is required. The FM demodulator marked IC2 provides such a signal originally intended to drive squelch circuitry. The last stage of acquiring a receive signal is to verify that the incoming CTCSS frequency is correct. To do this we tap the signal marked RX_DATA above (from JC12 to the CPU). To control the audio output and squelch we need to disconnect the CPU from the lines marked RX_PATH and AUDIO_MUTE and also control these externally. To know when to transmit and when to change channels the PIT, and UP/DOWN button signals must also be tapped. In the modified radio, the radio CPU retains control of the radio LCD that displays the selected channel and CTCSS code. To make the radio easier to use, the UP/DOWN buttons are retasked to change the CTCSS code selection (virtual channel) on the LCD. This retasking requires that the CPU UP/DOWN button inputs be disconnected from the buttons themselves and controlled externally. Lastly, other signals not pictured must be modified. The RX power down line must be disabled so that we can scan continuously and the EEPROM used to store the previous channel must be write protected so that the radio CPU always starts in the same state.

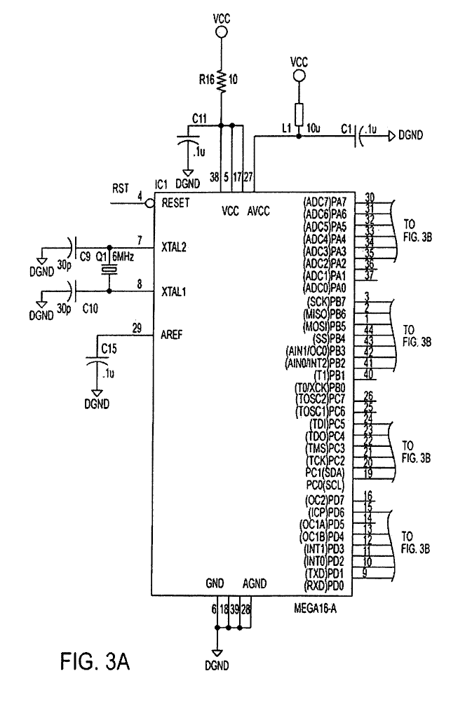

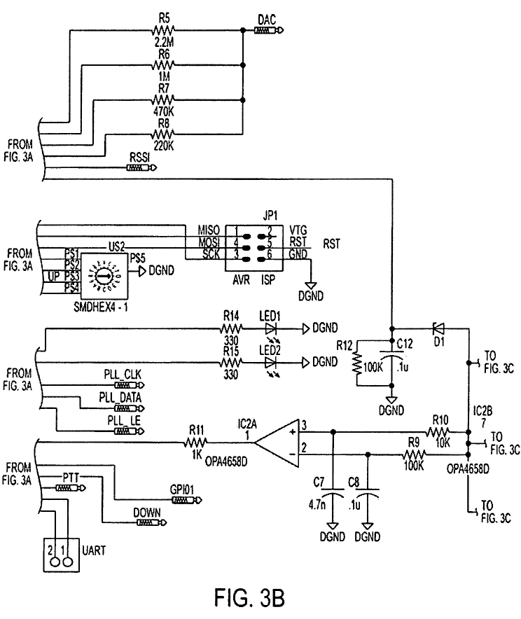

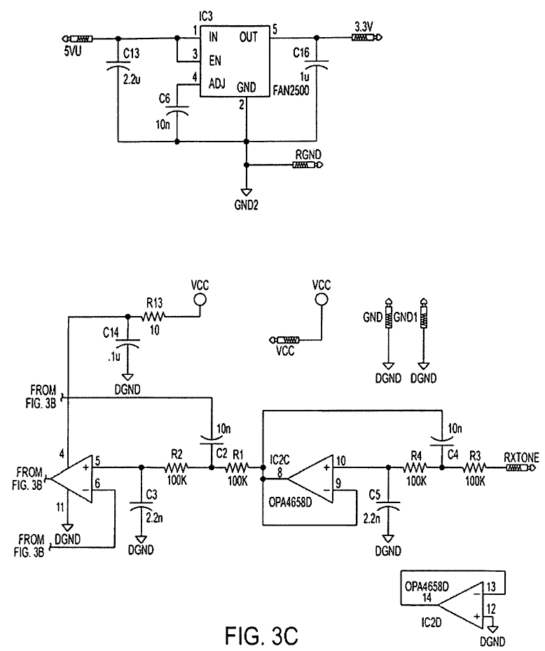

To process and control all of the signals mentioned in the previous paragraph, we created an add-on daughterboard to fit inside the radio case. This daughterboard contains a microcontroller that controls the radio PLL, detects channel signal levels, processes incoming tone signals and controls the radio CPU (which is responsible for TX CTCSS tone generation and the LCD). The schematic for this board is shown in FIG. 3.

The signal flow through this board is as follows. Incoming power from the batteries is regulated and supplied at 3.3V to the rest of the circuit by IC3. The daughterboard is powered from this regulator rather than the radio 3.3V supply because it was determined that power switching transients from the microcontroller were adversely affecting the performance of the VCO. The lines marked PLL_CLK, PLL_DATA and PLL_LE control the respective lines on the PLL chip. The incoming RSSI signal is connected directly to an ADC input on the microcontroller. The incoming received CTCSS tone is filtered by a 4^{th} order 250 Hz low-pass comprised by IC2B and IC2C to remove any audible signals before passing into zero crossing detector IC2A. The output of the zero crossing detector is connected to the microcontroller where it is further processed in software. The microcontroller is clocked by an external crystal at 6 MHz rather than its internal oscillator to achieve the required frequency stability to adequately detect the CTCSS tones with the required ±1.5% precision. The 6 MHz crystal was also chosen because it can be divided to accurately produce the baud clock needed for our 56.7 Kbps serial debugger. The microcontroller is also connected to an in system programming connector lPI and the serial debug header marked DART. Addition digital I/O lines are connected to the radio buttons and the RX_PATH and AUDIO_MUTE signals discussed above.

Most of the high level functionality of the board is implemented in the microcontroller firmware. The microcontroller software implements the following algorithm.

```
MAIN:
  INITIALIZE_HARDWARE ( );
  while ( True)
    TUNE_TO_NEXT_CHANNEL ( );
    MEASURE RSSI ( );
    if ( RSSI > Threshold)
      CHECK_CTCSS ( );
      while (CTCSS == Selected_CTCSS )
        OPEN_SQUELCH ( );
      CLOSE_SQUELCH ( );
```

The following routines are interrupt driven:

```
PIT_PRESSED:
  FIND_FREE_CHANNEL ( );
  TUNE_TO_FREE_CHANNEL ( );
  WAIT_UNTIL_PTT_RELEASE( );
UP_PRESSED:
  INCREMENT_SELECTED_CTCSS ( );
  UPDATE_RADIO_MICROCONTROLLER_CTCSS ( );
DOWN_PRESSED:
  DECREMENT_SELECTED_CTCSS ( );
  UPDATE_RADIO_MICROCONTROLLER_CTCSS 0;
```

Most of the above utility routines are relatively straightforward, however the CTCSS detection routine deserves more attention. The output of the zero crossing detector is connected to a special piece of hardware in the microcontroller that attaches a timestamp to any edge event and then triggers an interrupt. The interrupt service routine for this interrupt uses the timestamp of the most recent zerocrossing and the timestamp of the previous zero crossing to compute the half-period of the input waveform. The ISR also counts the number of times that it has been executed so that it can run for two full cycles of the CTCSS tone and then produce an average period and frequency estimate. The CHECK_CTCSS 0 call above enables this interrupt routine and waits for the interrupt routine to return the frequency estimate. Once the frequency estimate has been returned, the estimated value is compared the selected CTCSS tone frequency to determine if there is a match. The actual CHECK_CTCSS 0 routine is called twice when initially acquiring a new signal as sometimes the PLL has stabilized in time for the first call to give a good reading. While zero crossing is one technique for detecting the CTCSS tones, other techniques may be used. Furthermore, while the CTCSS tones are described here as the virtual channel codes, other virtual channel codes may be used in connection with the present invention instead of CTCSS tones. Such other techniques may include analog or digital signaling methods. Such analog methods may include variants of CTCSS type continuous tone systems (i.e.: using different frequencies or wave shapes) or entirely new methods such as those incorporating multiple simultaneous waveforms. Practicable digital signaling methods may include but are not limited to BPSK, QPSK, FSK, QAM and other common digital modulation schemes. Furthermore, it is expected that devices employing any analog or digital signaling methods may use signal acquisition and detection methods other than those implemented in the reference design.

To implement this exemplary embodiment of the present invention, an add-on daughterboard was created that was retrofitted into the existing FRS radio design. Furthermore the embodiment of the present invention to be implemented by the daughter board addresses the limitations of the existing CTCSS protocol.

On of the features of this exemplary embodiment of the present invention is that it meets the rules for the FRS service set down by the FCC. The radio and protocol of this embodiment of the present invention met the FCC rules with the exception that the example embodiment was not type certified to operate in the FRS band. However, there is nothing to indicate that type certification could not be achieved with the proper funding and test equipment.

The next feature was to improve FRS spectrum utilization. The exemplary embodiment definitely improved spectrum utilization over existing radios. The exemplary embodiment system can achieve full utilization of all 14 channels simultaneously in most situations. This performance is insured by the protocol's feature that radios acquire a free channel before transmitting.

A further featured was a reduction in the likelihood of transmit collisions. The exemplary embodiment creates 38 virtual channels up from the previous 14. In addition it automatically selects a free channel before transmission. This eliminates the primary problem with CTCSS TX collisions where a user assumes a channel is free because he doesn't hear anything. A collision will only occur if all 14 channels are in use even if multiple users are transmitting with the same code.

An additional feature of this embodiment is an improved user interface. This was accomplished with the automatic channel selection algorithm. This algorithm eliminates the need for the channel busy indicator used in CTCSS. This indicator was a prime usability problem.

Finally, the exemplary embodiment maintained costs in line with normal FRS radios. The total cost of the daughterboard was $8 in parts. This alone is enough to achieve the requirement. However, the manufacturer of our radio could have implemented our entire design with no significant design changes, resulting in negligible additional cost.

The exemplary embodiment of the present invention further met the following specification goals:

### Physical Size:

We specified that our modifications should not enlarge the form factor of the radio. Our design fits into the stock case.

### Battery Life:

The specified requirement was 24 hours for a nominal draw of 42 mA. We achieve a nominal draw of 37 mA for a lifetime of 27 hours.

### Range:

We specified that the radio range should not be degraded by our technology. A side by side test of an unmodified radio and a modified radio revealed very similar range performance.

### Latency:

We required that our project achieve a latency of better than 500 ms. Our measurements show average latency of about 300 ms with worst case latency of about 750 ms. These numbers meet our requirements but could be improved with a more sophisticated PLL design.

The foregoing description of the preferred embodiment of the invention has been presented for purposes of illustration and description. It is not intended to be exhaustive or to limit the invention to the precise form disclosed, and modifications and variations are possible in light of the above teachings or may be acquired from practice of the invention. The embodiment was chosen and described in order to explain the principles of the invention and its practical application to enable one skilled in the art to utilize the invention in various embodiments as are suited to the particular use contemplated. It is intended that the scope of the invention be defined by the claims appended hereto, and their equivalents. The entirety of each of the aforementioned documents is incorporated by reference herein.

What is claimed is:

1. A method of two-way radio communication using a radio having a memory, a plurality of channels, a plurality of virtual channel codes and a transmit button, wherein said radio has a current channel stored in said memory, comprising the steps of:
(1) storing a selected virtual channel code in said memory;
(2) determining whether said current channel is clear when said transmit button is pressed;
(3) changing said current channel stored in memory to a different channel if said current channel is not clear;
(4) repeating steps (2) and (3) until a clear channel is found; and
(5) when a clear channel is found, transmitting audio and said selected virtual channel code on said clear channel.

2. A method of two-way radio communication according to claim 1, wherein said virtual channel code is a CTCSS tone.

3. A method of two-way radio communication according to claim 1, wherein said plurality of channels comprise a lowest channel, highest channel and a plurality of channels in between said lowest channel and said highest channel and said step of changing said current channel stored in memory to a different channel comprises incrementing said current channel by one from said lowest channel to said highest channel and returning to said lowest channel after determining that said highest channel is not clear.

4. A method of two-way radio communication according to claim 1, wherein said step of changing said current channel stored in memory to a different channel comprises selecting a new channel randomly.

5. A method of two-way radio communication according to claim 1, wherein a user selects said virtual channel code.

6. A method of two-way radio communication using a radio having a memory, a plurality of channels, a plurality of virtual channel codes and a transmit button, wherein said radio has a current channel stored in said memory, comprising the steps of:
(1) storing a selected virtual channel code in said memory;
(2) determining whether said current channel in said radio is clear;
(3) if said current channel in said second radio is clear, changing said current channel stored in said memory of said second radio to a different channel;
(4) repeating steps (2) and (3) until a channel is found that is not clear;
(5) when a channel that is not clear is found, determining whether a received virtual channel code matches said selected virtual channel code, unsquelching a receiver in said radio if said received virtual channel code matches said selected virtual channel code, and squelching said receiver, changing said current channel to a different channel, and returning to step (2) if said received virtual channel code does not match said selected virtual channel code.

7. A method of two-way radio communication using a plurality of radios each having a memory, a plurality of channels, a plurality of virtual channel codes and a transmit button, wherein each said radio has a current channel stored in said memory, comprising the steps of:
(1) storing a selected virtual channel code in said memory of each of a first and second of said plurality of radios;
(2) determining whether said current channel of said first radio is clear when said transmit button on said first radio is pressed;
(3) changing said current channel stored in said memory of said first radio to a different channel if said current channel is not clear;
(4) repeating steps (2) and (3) until a clear channel is found; and
(5) when a clear channel is found, transmitting audio and said selected virtual channel code on said clear channel.

8. A method of two-way radio communication according to claim 7, further comprising the steps of:
(6) determining whether said current channel in said second radio is clear;
(7) if said current channel in said second radio is clear, changing said current channel stored in said memory of said second radio to a different channel;
(8) repeating steps (6) and (7) until a channel is found that is not clear;
(9) when a channel that is not clear is found, determining whether a received virtual channel code matches said selected virtual channel code, unsquelching a receiver in said second radio if said received virtual channel code matches said selected virtual channel code, and squelching said receiver, changing said current channel to a different channel, and returning to step (6) if said received virtual channel code does not match said selected virtual channel code.
